(19) United States
(12) Patent Application Publication
(10) Pub. No.: US 2018/0334187 A1
(43) Pub. Date: Nov. 22, 2018

(54) STEERING SYSTEM

(71) Applicant: JTEKT CORPORATION, Osaka (JP)

(72) Inventor: Hideya KATO, Okazaki-shi (JP)

(73) Assignee: JTEKT CORPORATION, Osaka (JP)

(21) Appl. No.: 15/976,230

(22) Filed: May 10, 2018

(30) Foreign Application Priority Data
May 18, 2017 (JP) 2017-099181

(51) Int. Cl. B62D 7/22; B62D 3/12; B62D 5/04; B62D 7/16

(52) U.S. Cl. CPC B62D 7/228; B62D 7/163; B62D 5/0463; B62D 3/12

(57) ABSTRACT

An end damper capable of providing an impact absorbing function with a short stroke is provided. A steering system includes: a large-diameter members attached one to each axial end of a rack shaft; a rack housing having stopper portions which the corresponding large-diameter members approach and separate from, the rack housing holding the rack shaft and the large-diameter members movably in an axial direction; and end dampers each of which absorbs impact by being held between the corresponding large-diameter member and the corresponding stopper portion in the axial direction. Each end damper includes: a first elastic member that is elastically deformed by being held; and a second elastic member that is elastically deformed such that an elastic modulus of the entire end damper is greater than an elastic modulus of the first elastic member, by receiving a load resulting from the elastic deformation of the first elastic member.

### INCORPORATION BY REFERENCE

The disclosure of Japanese Patent Application No. 2017-099181 filed on May 18, 2017 including the specification, drawings and abstract, is incorporated herein by reference in its entirety.

### BACKGROUND OF THE INVENTION

### 1. Field of the Invention

The invention relates to a steering system.

### 2. Description of the Related Art

There is known a steering system that steers the steered wheels of a vehicle (see, for example, Japanese Patent Application Publication No. 2016-97840). The steering system includes a steered shaft, a housing, and end dampers. The steered shaft is a shaft for steering the steered wheels, and extends in a vehicle width direction. The steered shaft is a shaft member that changes the direction of the steered wheels by moving in the axial direction. The housing is a member formed in a cylindrical shape having an insertion hole for insertion of the steered shaft, and holds the steered shaft movably in the axial direction.

Shaft end members serving as joints for coupling to the steered wheels are attached one to each end of the steered shaft. Each shaft end member is formed to have an outside diameter greater than the outside diameter of the main body of the steered shaft. The housing includes stopper portions which the corresponding shaft end members move to approach and separate from. Each stopper portion is a wall member projecting radially inward from the inner surface of the housing. The stopper portion has a function that restricts the steered shaft from moving a distance greater than a predetermined stroke in the axial direction.

Each end damper is disposed between the corresponding shaft end member and the corresponding stopper portion. The end damper has a function of absorbing impact between the shaft end member and the stopper portion of the housing by being held therebetween. The end damper includes an elastic member having elasticity, and a plate member that holds the elastic member. The elastic member is made of an elastic material such as rubber and synthetic resin. The plate member is formed of a metal material, for example.

The plate member has an L-shaped cross section. The plate member includes a cylindrical portion, and a flange portion extending radially outward from a first end of the cylindrical portion in the axial direction. The flange portion of the plate member defines an abutment face against which the shaft end member abuts. The abutment face of the flange portion of the plate member has a plurality of grooves disposed at regular intervals in the circumferential direction. The grooves serve as passages for releasing compressed air when the shaft end member abuts against the flange portion of the plate member. The grooves have a function of reducing an increase in the pressure inside the space, and a function of increasing the bending strength of the flange portion. Further, the elastic member is compressed and deformed in the axial direction by being held between the shaft end member and the stopper portion. When the compression deformation of the elastic member in the axial direction progresses, the outer peripheral side of the elastic member is expanded and deformed radially outward, while the inner peripheral side of the elastic member is blocked by the cylindrical portion of the plate member. The elastic member is expanded and deformed radially outward to fill the clearance between the outer peripheral surface of the elastic member and the inner surface of the housing.

However, with the configuration of the end damper described above, the impact between the shaft end member and the stopper portion is absorbed by compression deformation of the elastic member alone. That is, even when the elastic member is expanded and deformed radially outward due to compression deformation, the expanded and deformed portion merely fills the clearance between the outer peripheral surface of the elastic member and the inner surface of the housing, and the expansion deformation does not contribute to impact absorption. Therefore, in the case where the impact is absorbed by compression deformation of the elastic member alone, the elastic member needs to have a long stroke in the axial direction.

### SUMMARY OF THE INVENTION

An object of the invention is to provide a steering system capable of providing an impact absorbing function with a short stroke in the axial direction.

A steering system according to an aspect of the invention includes: a steered shaft that is coupled to steered wheels, and changes a direction of the steered wheels by moving in an axial direction; shaft end members that are attached one to each axial end of the steered shaft, and move in the axial direction along with the movement of the steered shaft; a cylindrical housing having an insertion hole for insertion of the steered shaft, and stopper portions which the corresponding shaft end members move to approach and separate from, the housing holding the steered shaft and the shaft end members movably in the axial direction; and end dampers each of which absorbs impact by being held between the corresponding shaft end member and the corresponding stopper portion in the axial direction; wherein each of the end dampers includes a first elastic member that is disposed between the shaft end member and the stopper portion, and is elastically deformed by being held between the shaft end member and the stopper portion in the axial direction, and a second elastic member that is disposed adjacent to the first elastic member, and is elastically deformed such that an elastic modulus of the entire end damper is greater than an elastic modulus of the first elastic member, by receiving a load resulting from the elastic deformation of the first elastic member.

With this configuration, when the first elastic member disposed between the shaft end member and the stopper portion is elastically deformed by being held therebetween in the axial direction, the second elastic member disposed adjacent to the first elastic member is elastically deformed such that the elastic modulus of the entire end damper is greater than the elastic modulus of the first elastic member, by receiving a load resulting from the elastic deformation of the first elastic member. Therefore, it is possible to absorb impact by elastic deformation of the first elastic member and elastic deformation of the second elastic member. Thus, according to the steering system, compared to the configuration that absorbs impact by elastic deformation of the first elastic member alone, it is possible to reduce the stroke of the first elastic member in the axial direction when providing the impact absorbing function of the end damper.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 illustrates the overall configuration of a steering system according to an embodiment of the present invention;

FIG. 2 is a cross-sectional view illustrating a main part of the steering system according to the embodiment;

FIG. 3 is an exploded perspective view illustrating an end damper of the steering system (including a partially cut off view of a first elastic member) according to the embodiment;

FIG. 4 is an enlarged cross-sectional view illustrating the end damper before abutment of a shaft end member and a stopper portion in the steering system according to the embodiment;

FIG. 5 is an enlarged cross-sectional view illustrating the end damper upon abutment of the shaft end member and the stopper portion in the steering system according to the embodiment;

FIG. 6 is an enlarged cross-sectional view illustrating the end damper after abutment of the shaft end member and the stopper portion and elastic deformation of the second elastic member in the steering system according to the embodiment;

FIG. 7 illustrates a comparison between the end damper of the embodiment and an end damper having a comparative configuration, with regard to the relationship between the stroke of a first elastic member in the axial direction and the amount of absorption energy after abutment of the shaft end member against the stopper portion, according to the embodiment;

FIG. 8 is an enlarged cross-sectional view illustrating a main part of an end damper included in a steering system before and after impact absorption according to a first modified embodiment;

FIG. 9 is an enlarged cross-sectional view illustrating a main part of an end damper included in a steering system before and after impact absorption according to a second modified embodiment;

FIG. 10 is an enlarged cross-sectional view illustrating a main part of an end damper included in a steering system before abutment according to a third modified embodiment;

FIG. 11 is an enlarged cross-sectional view illustrating the main part of the end damper of FIG. 10 upon abutment;

FIG. 12 is an enlarged cross-sectional view illustrating the main part of the end damper of FIG. 10 after abutment and after the start of elastic deformation of a second elastic member;

FIG. 13 is an enlarged cross-sectional view illustrating a main part of an end damper included in a steering system according to a fourth modified embodiment;

FIG. 14 is an enlarged cross-sectional view illustrating a main part of an end damper included in a steering system according to a fifth modified embodiment;

FIG. 15 is an enlarged cross-sectional view illustrating a main part of an end damper included in a steering system according to another modified embodiment;

FIG. 16 is a perspective view illustrating a second elastic member of an end damper included in a steering system according to another modified embodiment; and

FIG. 17 is a perspective view illustrating a second elastic member of an end damper included in a steering system according to another modified embodiment.

### DETAILED DESCRIPTION OF EMBODIMENTS

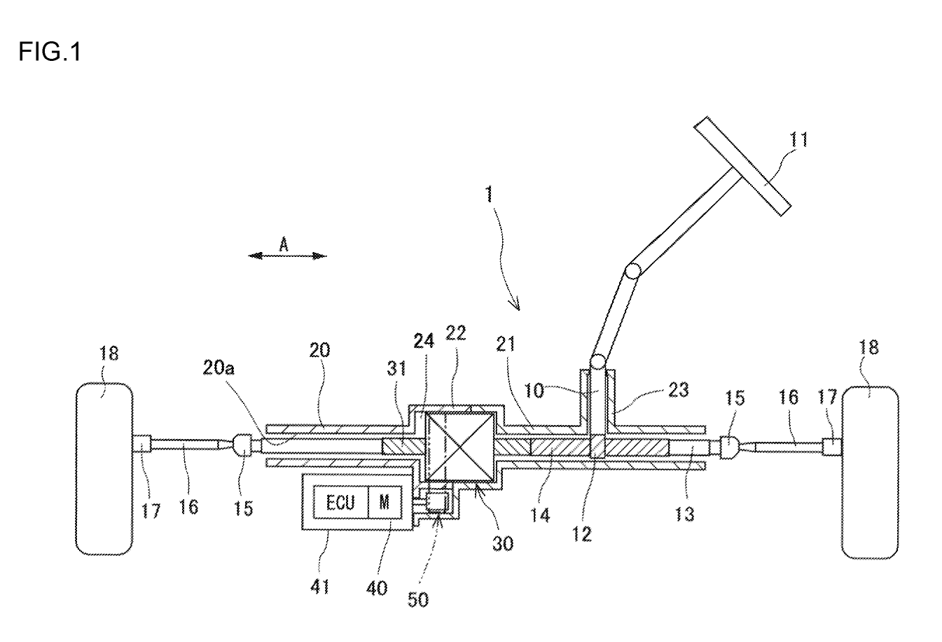

The configuration of a steering system 1 according to an embodiment of the present invention will be described with reference to FIGS. 1 to 9. The steering system 1 is a system that moves a rack shaft serving as a steered shaft in an axial direction in which the rack shaft extends, and thereby steers the steered wheels respectively coupled to the opposite ends of the rack shaft.

As illustrated in FIG. 1, the steering system 1 includes a steering shaft 10. A steering wheel 11 is coupled to an end of the steering shaft 10 that can be rotated by a vehicle driver. The steering shaft 10 is rotatably held by a rack housing 20 supported by a vehicle body, and rotates with rotation of the steering wheel 11. A pinion 12 included in a rack-and-pinion mechanism is formed at the other end of the steering shaft 10.

The steering system 1 includes a rack shaft 13 as a steered shaft extending in the vehicle width direction, that is, an axial direction A. A rack 14 included in the rack-and-pinion mechanism together with the pinion 12 is formed at a portion of the rack shaft 13 that is deviated to one side thereof. The pinion 12 of the steering shaft 10 and the rack 14 of the rack shaft 13 mesh with each other. The steering shaft 10 transmits a torque that is applied to the steering wheel 11 by rotational operation (that is, steering operation) performed by the vehicle driver to the rack shaft 13. The rotation of the steering shaft 10 is converted by the rack-and-pinion mechanism into linear movement of the rack shaft 13 in the axial direction A. The rack shaft 13 moves in the axial direction A as the steering shaft 10 rotates.

Tie rods 16 are swingably coupled to the opposite axial ends of the rack shaft 13 via ball joints 15. Steered wheels 18 are coupled to the tie rods 16 via knuckle arms 17. The steered wheels 18 are steered as the rack shaft 13 moves in the axial direction A. The vehicle is steered right and left as the steered wheels 18 are steered.

The steering system 1 includes a ball screw mechanism 30, an electric motor 40, and a driving force transmission device 50. The steering system 1 can assist the steering torque when the vehicle driver rotates the steering wheel 11, using the electric motor 40 as a driving source. The steering system 1 transmits an assist rotational torque generated by the electric motor 40 to the ball screw mechanism 30 serving as a gear device via the driving force transmission device 50, and converts the assist rotational torque into a force that linearly moves the rack shaft 13 in the axial direction A via the ball screw mechanism 30. With this conversion, an assist force that assists steering of the steered wheels 18 is applied to the rack shaft 13. The steering system 1 is a so-called rack parallel type electric power steering system.

The ball screw mechanism 30 includes a ball screw portion 31 and a ball screw nut (not illustrated). The ball screw portion 31 is an outer peripheral groove that serves as a helical screw groove having a plurality of turns on the outer peripheral surface of the rack shaft 13. The ball screw nut is a cylindrical member formed in a cylindrical shape and extending in the axial direction A, and is disposed coaxially with the rack shaft 13. The ball screw nut has an inner peripheral groove that serves as a helical screw groove having a plurality of turns on its inner peripheral surface. The outer peripheral groove of the ball screw portion 31 and the inner peripheral groove of the ball screw nut are arranged to face each other in the radial direction, and are in threaded engagement with each other via a plurality of rolling balls that are endlessly circulated by a deflector (not illustrated) mounted to the ball screw nut.

The rack shaft 13 is inserted through the rack housing 20 to be movable in the axial direction A, and is held by the rack housing 20. The rack housing 20 is a housing formed in a substantially cylindrical shape and extending in the axial direction A, and covers and holds the rack shaft 13 movably in the axial direction A. The rack housing 20 includes an insertion hole 20a for insertion of the rack shaft 13. The rack housing 20 is formed of aluminum or the like. The rack housing 20 includes a small-diameter portion 21 having a bore diameter slightly greater than the outside diameter of the rack shaft 13, and a large-diameter portion 22 having a bore diameter greater than the bore diameter of the small-diameter portion 21.

A steering shaft insertion portion 23 for insertion of the steering shaft 10 is coupled to the small-diameter portion 21. The large-diameter portion 22 accommodates the ball screw mechanism 30, and also accommodates the driving force transmission device 50. The large-diameter portion 22 has a ball screw chamber 24 that mainly accommodates the ball screw nut and the rolling balls. The large-diameter portion 22 is disposed at substantially the axial center of the rack housing 20. The rack housing 20 may be separable in the axial direction A such that the large-diameter portion 22 can accommodate the ball screw nut of the ball screw mechanism 30 and the driving force transmission device 50.

The electric motor 40 is accommodated in a case 41 fixed near the large-diameter portion 22 of the rack housing 20. The electric motor 40 is arranged such that its output shaft is parallel to the axial direction A of the rack shaft 13. The electric motor 40 generates an assist rotational torque in accordance with a command from the electronic control unit. The assist rotational torque generated by the electric motor 40 is transmitted to the driving force transmission device 50.

The driving force transmission device 50 may include a driving pulley attached and fixed to the output shaft of the electric motor 40 and having external teeth, a driven pulley attached and fixed to the ball screw nut of the ball screw mechanism 30 and having external teeth, and a rubber belt formed in an annular belt shape and having internal teeth that mesh with the external teeth of the driving pulley and the driven pulley. When an assist rotational torque is transmitted from the electric motor 40 to the driving force transmission device 50, the ball screw nut of the ball screw mechanism 30 is rotated while being supported via a bearing with respect to the large-diameter portion 22 of the rack housing 20, so that the rack shaft 13 is moved in the axial direction A via the plurality of rolling balls.

In the steering system 1 described above, when the steering wheel 11 is rotated, the steering torque is transmitted to the steering shaft 10, so that the rack shaft 13 is moved in the axial direction A via the rack-and-pinion mechanism including the pinion 12 and the rack 14. The steering torque transmitted to the steering shaft 10 is detected using a torque sensor or the like. The output of the electric motor 40 is controlled based on the steering torque and the rotational position of the electric motor 40. The electric motor 40 generates an assist rotational torque in accordance with a command from the electronic control unit. When the electric motor 40 generates an assist rotational torque, the rotational torque is transmitted to the ball screw mechanism 30 via the driving force transmission device 50, and is converted into a driving force for moving the rack shaft 13 in the axial direction A.

When the rack shaft 13 is moved in the axial direction A, the direction of the steered wheels 18 is changed via the ball joints 15, the tie rods 16, and the knuckle arms 17. Accordingly, in the steering system 1, the rack shaft 13 can be moved in the axial direction A by applying, together with a steering torque of the driver to the steering shaft 10, an assist rotational torque of the electric motor 40 in accordance with the steering torque to the rack shaft 13. Therefore, it is possible to reduce the amount of steering force required for the driver to operate the steering wheel 11.

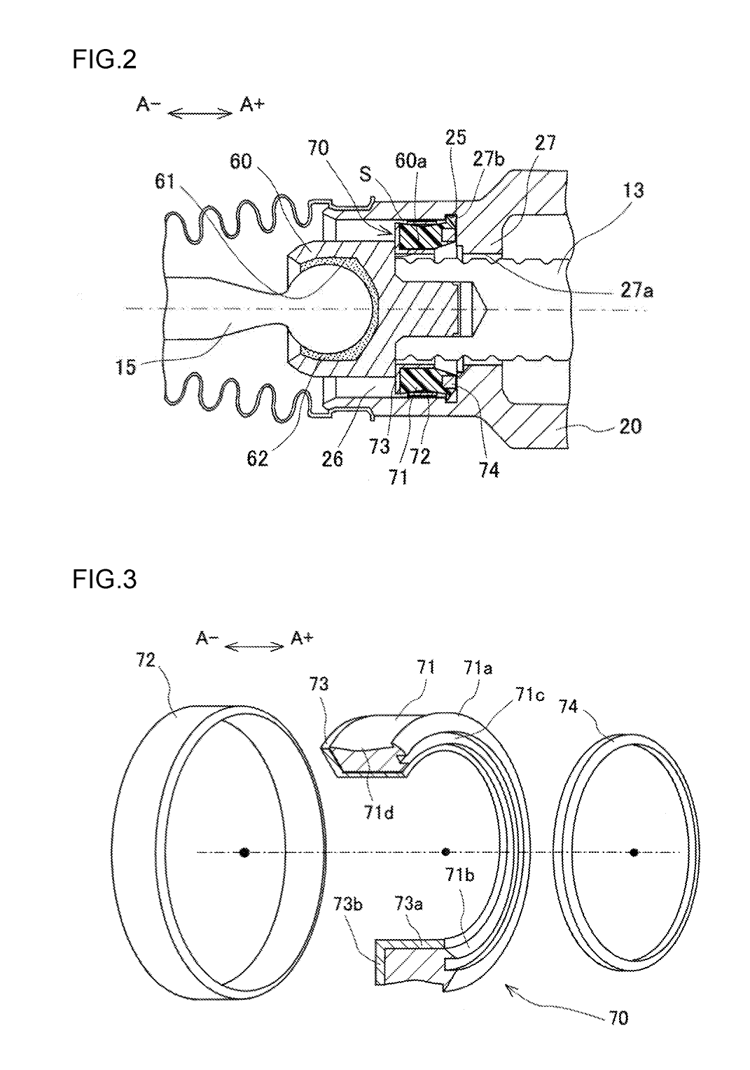

As illustrated in FIG. 2, in the steering system 1, large-diameter members 60 serving as shaft end members are attached one to each axial end of the rack shaft 13. Each large-diameter member 60 is coaxially coupled to the rack shaft 13, and has an outside diameter greater than the outside diameter of the rack shaft 13. Each large-diameter member 60 has a substantially spherical aperture 61 that is open toward a first end direction of the axial direction A (that is, an axially outward direction A− in FIG. 2). A ball head of a ball stud included in the ball joint 15 is rotatably accommodated in the aperture 61 via a buffer 62.

The rack housing 20 includes large-diameter accommodation chambers 26 capable of accommodating the large-diameter members 60, one at each axial end (specifically, the end of the small-diameter portion 21 of each axial end in the axially outward direction A−). The rack housing 20 is formed such that the large-diameter accommodation chamber 26 has a bore diameter greater than the outside diameter of the large-diameter member 60. The bore diameter of the large-diameter accommodation chamber 26 is greater than the bore diameter of the main body (that is, the insertion hole 20a) of the rack housing 20.

The rack housing 20 has stopper portions 27 extending radially inward from its inner surface. Each stopper portion 27 is a wall member extending radially inward from the cylindrical inner surface of the main body (specifically, the small-diameter portion 21) of the rack housing 20 and formed in an annular shape. The stopper portions 27 are provided one at each axial end of the rack housing 20. Each stopper portion 27 has a function that restricts the rack shaft 13 from moving a distance greater than a predetermined stroke in a second end direction of the axial direction A (that is, an axially inward direction A+ in FIG. 2). Each large-diameter member 60 of the rack shaft 13 is disposed on the axially outward direction A− side with respect to the stopper portion 27, and moves in the axial direction A to approach and separate from the stopper portion 27.

Each stopper portion 27 has an insertion hole 27a for insertion of the rack shaft 13 at the axial center thereof. The insertion hole 27a has a circular shape corresponding to the outer shape of the rack shaft 13. The insertion hole 27a has a diameter greater than the outside diameter of the rack shaft 13, and less than the outside diameter of the large-diameter member 60. The stopper portion 27 includes an axial end face 27b facing the axially outward direction A−. The axial end face 27b is an abutment face that abuts against an axial end face 60a of the large-diameter member 60 facing the axially inward direction A+, via an end damper 70 described below. The stopper portion 27 abuts at the axial end face 27b against the axial end face 60a of the large-diameter member 60 via the end damper 70, and thereby restricts the rack shaft 13 with the large-diameter member 60 coupled thereto from moving further in the axially inward direction A+. The stopper portion 27 has a sufficient axial thickness to withstand a predetermined pressing force applied from the large-diameter member 60 side and restrict the rack shaft 13 from moving a distance greater than a predetermined stroke.

The steering system 1 includes the end dampers 70. Each end damper 70 is a device that absorbs impact between the large-diameter member 60 and the stopper portion 27, by being held between the axial end face 60a of the large-diameter member 60 and the stopper portion 27 of the rack housing 20, when the rack shaft 13 moves a distance greater than the predetermined stroke in the axial direction A. The end damper 70 absorbs the impact, and thus can prevent the belt of the driving force transmission device 50 from skipping a tooth. The end dampers 70 are provided one on each axial side.

Each end damper 70 is disposed adjacent in the axially outward direction A− to the corresponding stopper portion 27. That is, the end damper 70 is interposed between the large-diameter member 60 of the rack shaft 13 and the stopper portion 27 of the rack housing 20. The end damper 70 reduces the impact force that is generated when the rack shaft 13 abuts against the rack housing 20, with use of an elastic member. As illustrated in FIG. 3, the end damper 70 includes two types of elastic members 71 and 72, a holding plate 73, and a ring plate 74.

The elastic member 71 is formed of a material such as rubber and resin having elasticity. The material of the elastic member 71 is, for example, crosslinked rubber, thermosetting or thermoplastic synthetic resin elastomer, or the like. The elastic member 71 is a member formed in a substantially cylindrical and substantially annular shape. The elastic member 71 has a sufficient thickness in each of the axial direction A and the radial direction to obtain a desired elastic modulus. The elastic member 71 is disposed between the axial end face 60a of the large-diameter member 60 of the rack shaft 13 and the axial end face 27b of the stopper portion 27 of the rack housing 20. The elastic member 71 can be elastically deformed (that is, compressed and deformed) in the axial direction A by being held between the large-diameter member 60 and the stopper portion 27 in the axial direction A. The elastic member 71 is compressed and deformed, and thereby absorbs impact between the large-diameter member 60 of the rack shaft 13 and the stopper portion 27 of the rack housing 20. The elastic member 71 is held by the holding plate 73. The elastic member 71 is integrated with the holding plate 73 by, for example, vulcanization bonding.

The holding plate 73 is formed of metal such as iron. The holding plate 73 is a plate member that holds the elastic member 71, and is a substantially cylindrical member having an L-shaped cross section. The holding plate 73 is a member that is pushed in the axially inward direction A+ when abutted by the axial end face 60a of the large-diameter member 60 of the rack shaft 13. The holding plate 73 applies a compression force in the axially inward direction A+ generated by being held between the large-diameter member 60 and the stopper portion 27 to the elastic member 71, and transmits the resulting impact force to the elastic member 71.

The holding plate 73 includes a cylindrical portion 73a and a flange portion 73b. The cylindrical portion 73a and the flange portion 73b are formed integrally with each other. The cylindrical portion 73a is a portion formed in a cylindrical shape extending in the axial direction A. The cylindrical portion 73a is in contact on its outer peripheral surface side with the elastic member 71. The cylindrical portion 73a has a through-hole for insertion of the rack shaft 13. The inner peripheral surface of the cylindrical portion 73a faces the outer peripheral surface of the rack shaft 13. The cylindrical portion 73a has a bore diameter greater than the outside diameter of the rack shaft 13. An end of the cylindrical portion 73a in the axially inward direction A+ faces the stopper portion 27 of the rack housing 20 in the axial direction A.

The cylindrical portion 73a is formed and arranged to have a predetermined clearance between the end of the cylindrical portion 73a in the axially inward direction A+ and the axial end face 27b of the stopper portion 27 when the elastic member 71 is not deformed. The predetermined clearance is set to be greater than the maximum compression allowance that is obtained when the elastic member 71 is compressed and deformed in the axially inward direction A+ by the expected maximum compression force. The cylindrical portion 73a has a function that restricts the elastic member 71 from being elastically deformed radially inward, and thereby prevents the elastic member 71 from interfering with the rack shaft 13. The bore-diameter-side end of the stopper portion 27 may have a notch such that the end of the cylindrical portion 73a in the axially inward direction A+ does not easily interfere with the stopper portion 27.

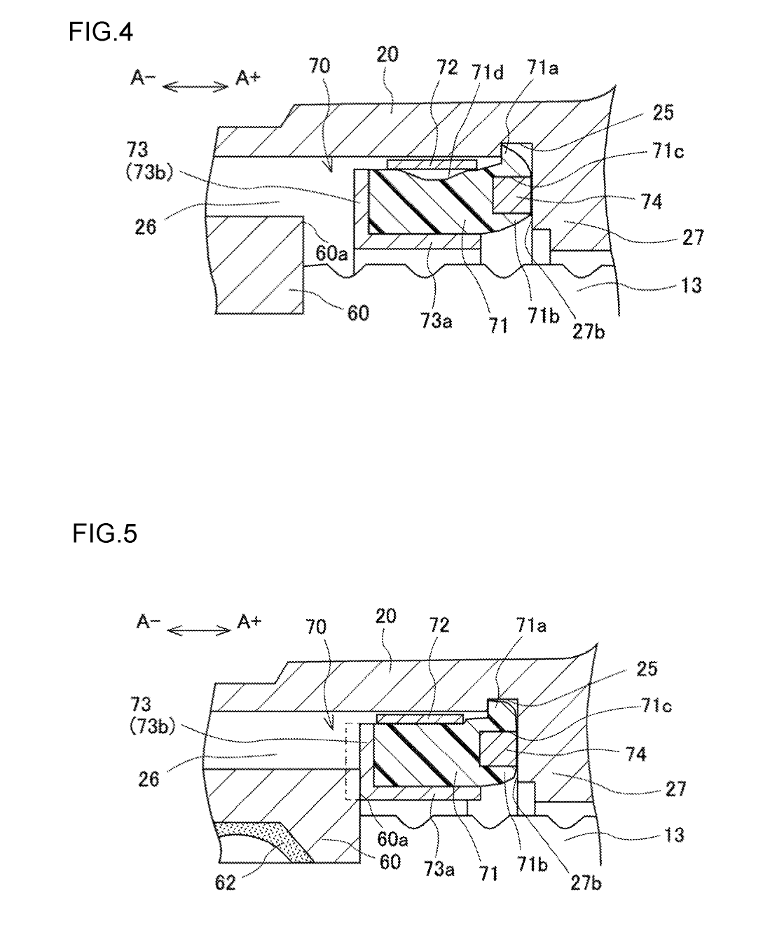

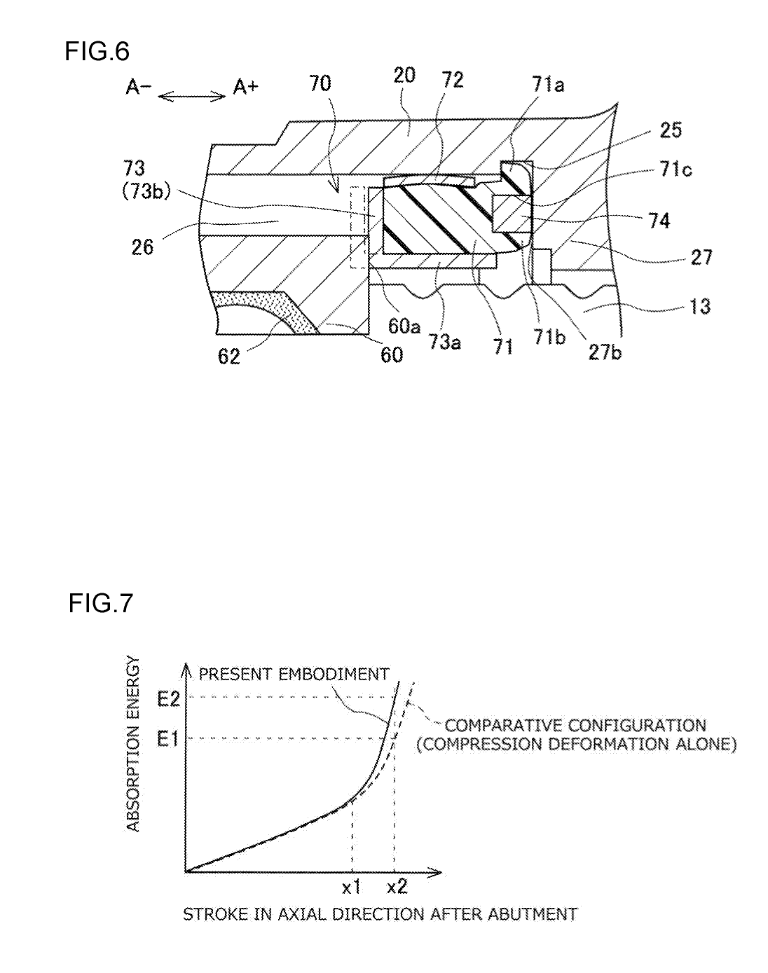

The flange portion 73b is a portion formed in an annular shape, and projects radially outward from the outer surface of the end of the cylindrical portion 73a on the axially outward direction A− side (that is, the axial end on the side of the large-diameter member 60 that can be in contact therewith). The flange portion 73b is interposed between the elastic member 71 and the large-diameter member 60. The flange portion 73b is in contact at its end face in the axially inward direction A+ with the elastic member 71, and faces the large-diameter member 60 of the rack shaft 13 in the axial direction A. The flange portion 73b is an abutment portion against which the large-diameter member 60 abuts. As illustrated in FIG. 4, the flange portion 73b and the large-diameter member 60 are out of contact with and spaced apart from each other in a normal movement range of the rack shaft 13 in the axial direction A. As illustrated in FIGS. 5 and 6, the flange portion 73b and the large-diameter member 60 are in contact with each other when its amount of movement is greater than the predetermined stroke.

The outside diameter of the flange portion 73b of the holding plate 73 is less than the bore diameter of the large-diameter accommodation chamber 26 of the rack housing 20. The outside diameter of the main body of the elastic member 71 substantially matches the outside diameter of the flange portion 73b. The outside diameter of the main body of the elastic member 71 is less than the bore diameter of the large-diameter accommodation chamber 26 of the rack housing 20 when the elastic member 71 is not deformed. There is a clearance between the outer peripheral surface of the elastic member 71 and the inner peripheral surface of the large-diameter accommodation chamber 26.

The elastic member 71 includes a projecting portion 71a projecting radially outward from the outer peripheral surface of the cylindrical main body of the elastic member 71. The projecting portion 71a is disposed at the end of the elastic member 71 in the axially inward direction A+ (that is, the axial end on the side of the stopper portion 27 that can be in contact therewith). The projecting portion 71a forms a flange shape for the main body of the elastic member 71, and is formed in an annular shape, or a plurality of the projecting portions 71a are arranged at regular intervals in the circumferential direction.

The large-diameter accommodation chamber 26 of the rack housing 20 includes a groove portion 25 to which the projecting portion 71a of the elastic member 71 fits. The projecting portion 71a of the elastic member 71 and the groove portion 25 of the rack housing 20 fit to each other such that the elastic member 71 and the holding plate 73 are positioned with respect to the rack housing 20 in the axial direction A. That is, the elastic member 71 and the holding plate 73 are positioned with respect to the rack housing 20 in the axial direction A by fitting the projecting portion 71a and the groove portion 25 to each other. After being assembled, the elastic member 71 and the holding plate 73 are maintained in the same positions with respect to the rack housing 20 before and after elastic deformation of the elastic member 71. Accordingly, once the projecting portion 71a fits to the groove portion 25, the elastic member 71 is prevented from coming off in the axial direction A even when the elastic member 71 is elastically deformed.

The elastic member 71 includes a tapered portion 71b having an increasing bore diameter on the inner peripheral side of the main body of the elastic member 71. The tapered portion 71b is disposed at the end of the elastic member 71 in the axially inward direction A+, and is formed such that the bore diameter is maximized at the axial end face of the elastic member 71. The tapered portion 71b is provided to prevent the elastic member 71 from extending radially inward from the clearance between the end of the cylindrical portion 73a of the holding plate 73 in the axially inward direction A+ and the axial end face 27b of the stopper portion 27 of the rack housing 20 when the elastic member 71 is compressed and deformed in the axially inward direction A+.

An open groove 71c that is open in the axially inward direction A+ is provided at the end of the elastic member 71 in the axially inward direction A+. The open groove 71c is an annular groove formed in the axial end face of the elastic member 71. The open groove 71c is disposed substantially at the radial center between the radially inner edge of the elastic member 71 on the cylindrical portion 73a side and the projecting portion 71a. The projecting portion 71a is located on the radially outer side with respect to the open groove 71c.

The ring plate 74 is interposed between the elastic member 71 and the stopper portion 27 of the rack housing 20. The ring plate 74 is disposed adjacent in the axially outward direction A− to the axial end face 27b of the stopper portion 27, and is in contact with the axial end face 27b of the stopper portion 27. The ring plate 74 is a plate member that is formed in a substantially annular shape, and fits to the open groove 71c of the elastic member 71. The ring plate 74 has a size that matches the size of the open groove 71c, has a radial thickness that is substantially equal to the radial width of the open groove 71c, and has an axial thickness that is substantially equal to the axial width of the open groove 71c. The ring plate 74 is formed of metal such as iron.

The ring plate 74 has an axial thickness sufficient to protect the projecting portion 71a and the tapered portion 71b of the elastic member 71 by suppressing deformation thereof. Further, the ring plate 74 has an axial length sufficient to secure a clearance between the cylindrical portion 73a of the holding plate 73 and the stopper portion 27 of the rack housing 20 even when deformation of the elastic member 71 is maximum. The ring plate 74 is fitted to the open groove 71c of the elastic member 71. The ring plate 74 faces the groove portion 25 of the large-diameter accommodation chamber 26 of the rack housing 20 in the radial direction, with the projecting portion 71a of the elastic member 71 interposed therebetween.

The ring plate 74 may be bonded and fixed to the elastic member 71. In this case, the ring plate 74 and the elastic member 71 may be bonded by vulcanization if the elastic member 71 is molded from a rubber material. Alternatively, the ring plate 74 may be insert-molded with the elastic member 71. The ring plate 74 is a member that can hold the elastic member 71 in the axial direction A between the end face in the axially outward direction A− (that is, on the axially front side) and the flange portion 73b of the holding plate 73, while being supported at the end face in the axially inward direction A+ (that is, axially back side) by the stopper portion 27 of the rack housing 20.

The elastic member 71 includes, on its outer peripheral surface side, a recessed portion 71d that is recessed radially inward, that is, toward the axial center. The recessed portion 71d is an annular groove that is open toward the radially outer side. The recessed portion 71d may be disposed at any position of the elastic member 71 in the axial direction. However, in order to promote elastic deformation of the second elastic member 72 described below, it is preferable that the recessed portion 71d is disposed in a region where expansion deformation of the elastic member 71 in the radial direction due to the compression deformation in the axial direction A is likely to be most prominent. For example, the recessed portion 71d is disposed at the axial center. The recessed portion 71d is covered on its outer peripheral side by the second elastic member 72 to be a closed clearance space. The recessed portion 71d is an area that is filled with, when the elastic member 71 is compressed and deformed in the axial direction A, part of the elastic member 71 that is expanded due to a change in volume associated with the compression deformation. The elastic member 72 is an elastic body provided separately from the elastic member 71 described above. The elastic member 71 and the elastic member 72 are hereinafter referred to as a first elastic member 71 and a second elastic member 72, respectively.

As described above, there is a clearance between the outer peripheral surface of the elastic member 71 and the inner peripheral surface of the large-diameter accommodation chamber 26 of the rack housing 20. The second elastic member 72 is formed of a material such as metal, rubber, and resin having elasticity. The second elastic member 72 is, for example, a plate spring member formed in a cylindrical annular shape. The second elastic member 72 has a flat plate shape in cross section. The second elastic member 72 is disposed adjacent to and on the radially outer side of the first elastic member 71, and faces the cylindrical portion 73a of the holding plate 73 in the radial direction, with the first elastic member 71 interposed therebetween. The second elastic member 72 is in contact with the first elastic member 71 throughout the circumference. The second elastic member 72 is disposed in a clearance between the outer peripheral surface of the first elastic member 71 described above and the inner peripheral surface of the large-diameter accommodation chamber 26 of the rack housing 20. The second elastic member 72 has a radial thickness smaller than the clearance. The radial thickness of the second elastic member 72 is adjusted to obtain a desired elastic modulus.

The second elastic member 72 is formed and arranged such that the end of the second elastic member 72 on the axially outward direction A− side does not interfere with the holding plate 73 even when the first elastic member 71 is compressed and deformed in the axial direction A. Further, the second elastic member 72 is formed and arranged to have a clearance from the ring plate 74 even when the first elastic member 71 is compressed and deformed in the axial direction A. The projecting portion 71a of the first elastic member 71 fits to the groove portion 25 of the rack housing 20 while extending radially outward from the clearance between the second elastic member 72 and the ring plate 74.

The second elastic member 72 is formed and arranged to be out of contact with the inner peripheral surface of the large-diameter accommodation chamber 26 of the rack housing 20, that is, to have a clearance S between the outer peripheral surface of the second elastic member 72 and the inner peripheral surface of the large-diameter accommodation chamber 26, when not deformed. The second elastic member 72 can elastically deform by expanding radially outward to fill the clearance S. The clearance S is maximized when the second elastic member 72 is not deformed, and decreases with progress of elastic deformation of the second elastic member 72. Note that in the case where the second elastic member 72 is made of a metal material, the second elastic member 72 and the first elastic member 71 may be integrated with each other by vulcanization bonding or the like.

The first elastic member 71 is held on its bore diameter side by the holding plate 73. Therefore, when the compression deformation in the axial direction A progresses, the first elastic member 71 is expanded and deformed radially outward while being held by the holding plate 73. The amount of deformation of the expansion deformation is greater toward the axial center of the first elastic member 71, and is less toward the axial ends. When the elastic member 71 is expanded and deformed, part of the first elastic member 71 first fills the recessed portion 71d. When the recessed portion 71d of the elastic member 71 is not completely filled, the load applied to the second elastic member 72 due to the expansion deformation is relatively small. Thereafter, when the expansion deformation of the first elastic member 71 progresses further and the recessed portion 71d is completely filled with the first elastic member 71, then there is no more space for the first elastic member 71. Accordingly, the load applied to the second elastic member 72 due to the expansion deformation becomes greater than that before the recessed portion 71d is filled.

The second elastic member 72 is elastically deformed radially outward by receiving a load resulting from the expansion deformation of the first elastic member 71 in the radial direction. That is, when receiving a radially outward load from the first elastic member 71, the second elastic member 72 is deflected such that its axial center portion expands radially outward. When the deflection occurs, the axial length of the second elastic member 72 is reduced. The second elastic member 72 is elastically deformed upon the deflection, thereby absorbs impact between the large-diameter member 60 of the rack shaft 13 and the stopper portion 27 of the rack housing 20.

In the steering system 1 including the end damper 70 described above, as illustrated in FIG. 4, the axial end face 60a of the large-diameter member 60 attached to the axial end of the rack shaft 13 is not in contact with the flange portion 73b of the holding plate 73 of the end damper 70. Then, when the amount of movement of the rack shaft 13 in the axially inward direction A+ exceeds the predetermined stroke, the axial end face 60a abuts against the flange portion 73b as illustrated in FIG. 5. Thus, a large impact force is applied from the large-diameter member 60 to the flange portion 73b of the holding plate 73.

When the impact force described above is applied to the flange portion 73b of the holding plate 73, the holding plate 73 is pushed and moved in the axially inward direction A+ toward the stopper portion 27 of the rack housing 20. In this case, the first elastic member 71 held by the holding plate 73 is pushed in the axially inward direction A+ together with the holding plate 73, and thus is elastically deformed. The elastic deformation of the first elastic member 71 includes compression deformation that occurs when the first elastic member 71 is held between the flange portion 73b of the holding plate 73 and the stopper portion 27 or the ring plate 74 in the axial direction A, and radially inward and radially outward expansion deformation that occurs when the compressed and deformed first elastic member 71 escapes to fill the clearance space including the recessed portion 71d.

After the large-diameter member 60 and the holding plate 73 abut against each other, the holding plate 73 starts to press the first elastic member 71 in the axially inward direction A+, so that the first elastic member 71 is elastically deformed with a predetermined elastic modulus. Note that, even when the first elastic member 71 is elastically deformed, the second elastic member 72 is hardly elastically deformed until the recessed portion 71d is completely filled by expansion deformation of the first elastic member 71 in the radial direction. Therefore, the impact force applied from the large-diameter member 60 to the end damper 70 is absorbed mainly by the elastic deformation of the first elastic member 71 until the recessed portion 71d of the first elastic member 71 is filled.

After the large-diameter member 60 and the holding plate 73 abut against each other, when the amount of movement of the first elastic member 71 in the axial direction A reaches a predetermined stroke xl, the recessed portion 71d of the first elastic member 71 is filled. After the recessed portion 71d of the first elastic member 71 is completely filled, the first elastic member 71 is elastically deformed in the axial direction A and pushes outward, in the space surrounded by the second elastic member 72, the cylindrical portion 73a and the flange portion 73b of the holding plate 73, and the ring plate 74, their contact faces that are present in all directions. If the expansion deformation of the first elastic member 71 continues even after the recessed portion 71d is completely filled, a large load resulting from the expansion deformation of the first elastic member 71 is applied to the second elastic member 72 adjacent to and on the radially outer side of the first elastic member 71. As illustrated in FIG. 6, when the load is applied to the second elastic member 72, the second elastic member 72 is pushed radially outward by the load to be expanded and elastically deformed.

The second elastic member 72 is elastically deformed with a predetermined elastic modulus. After the second elastic member 72 is elastically deformed, both the first elastic member 71 and the second elastic member 72 are elastically deformed in the entire end damper 70. Therefore, after the recessed portion 71d of the first elastic member 71 is filled, the impact force applied from the large-diameter member 60 to the end damper 70 is absorbed by both the elastic deformation of the first elastic member 71 and the elastic deformation of the second elastic member 72. The second elastic member 72 can continue to elastically deform until the second elastic member 72 abuts against the inner peripheral surface of the rack housing 20.

In this manner, the end damper 70 absorbs impact by elastic deformation of the first elastic member 71 alone until the amount of movement of the first elastic member 71 in the axial direction A after the abutment reaches the predetermined stroke xl (that is, until the recessed portion 71d of the first elastic member 71 is filled, or until elastic deformation of the second elastic member 72 starts). Then, after the recessed portion 71d of the first elastic member 71 is filled, the end damper 70 absorbs impact by both elastic deformation of the first elastic member 71 and elastic deformation of the second elastic member 72. The elastic modulus of the entire end damper 70 at the time when both the first elastic member 71 and the second elastic member 72 are elastically deformed is greater than the elastic modulus of the first elastic member 71.

Suppose that the elastic member included in the end damper is the only elastic member that is elastically deformed by being held between the large-diameter member 60 of the rack shaft 13 and the stopper portion 27 of the rack housing 20 in the axial direction A. According to this comparative configuration, it is necessary to provide impact absorption by compression deformation of the elastic member in the axial direction A alone. Accordingly, even when the elastic member is expanded and deformed in the radial direction due to the compression deformation in the axial direction A, the expansion deformation does not contribute to impact absorption. Note that, in the end damper having the comparative configuration, as illustrated in FIG. 7, E1 is the energy that absorbs impact when the amount of movement of the elastic member in the axial direction after the abutment reaches the predetermined stroke x2.

Meanwhile, the elastic members included in the end damper 70 of the present embodiment are the first elastic member 71 that is elastically deformed by being held between the large-diameter member 60 of the rack shaft 13 and the stopper portion 27 of the rack housing 20 in the axial direction A, and the second elastic member 72 that is elastically deformed by receiving a radially outward load resulting from the elastic deformation of the first elastic member 71. Therefore, in the case where the first elastic member 71 is expanded and deformed radially outward due to the compression deformation in the axial direction A, the recessed portion 71d is filled with the first elastic member 71, and thus the expansion deformation contributes to impact absorption by elastic deformation of the second elastic member 72. That is, it is possible to absorb impact by elastic deformation of the first elastic member 71 in the axial direction A and elastic deformation of the second elastic member 72 in the radial direction. In the end damper 70, as illustrated in FIG. 7, the energy that absorbs impact when the amount of movement of the elastic member 71 in the axial direction A after the abutment reaches the predetermined stroke x2 is E2, which is greater than E1 described above.

Therefore, in the end damper 70, compared to the end damper having the comparative configuration described above, it is possible to reduce the stroke of the first elastic member 71 in the axial direction A when providing the same impact absorbing function. Thus, according to the steering system 1, it is possible to reduce the stroke of the first elastic member 71 in the axial direction A when providing the impact absorbing function of the end damper 70, and it is possible to provide the impact absorbing function with a short stroke of the first elastic member 71 in the axial direction A.

The following describes the effects of the present embodiment. The steering system 1 of the present embodiment includes: the rack shaft 13 that is coupled to the steered wheels 18, and changes the direction of the steered wheels 18 by moving in the axial direction A; the large-diameter members 60 that are attached one to each axial end of the rack shaft 13, and move in the axial direction A along with the movement of the rack shaft 13; the cylindrical rack housing 20 having the insertion hole 20a for insertion of the rack shaft 13, and the stopper portions 27 which the corresponding large-diameter members 60 move to approach and separate from, the rack housing 20 holding the rack shaft 13 and the large-diameter members 60 movably in the axial direction A; and the end dampers 70 each of which absorbs impact by being held between the corresponding large-diameter member 60 and the corresponding stopper portion 27 in the axial direction A. Each of the end dampers 70 includes: the first elastic member 71 that is disposed between the large-diameter member 60 and the stopper portion 27, and is elastically deformed by being held between the large-diameter member 60 and the stopper portion 27 in the axial direction A; and the second elastic member 72 that is disposed adjacent to the first elastic member 71, and is elastically deformed such that the elastic modulus of the entire end damper 70 is greater than the elastic modulus of the first elastic member 71, by receiving a load resulting from the elastic deformation of the first elastic member 71.

With this configuration, when the first elastic member 71 disposed between the large-diameter member 60 and the stopper portion 27 is elastically deformed by being held therebetween in the axial direction A, the second elastic member 72 disposed adjacent to the first elastic member 71 is elastically deformed such that the elastic modulus of the entire end damper 70 is greater than the elastic modulus of the first elastic member 71, by receiving a load resulting from the elastic deformation of the first elastic member 71. Therefore, it is possible to absorb impact by elastic deformation of the first elastic member 71 and elastic deformation of the second elastic member 72. Thus, according to the steering system 1, compared to the configuration that absorbs impact by elastic deformation of the first elastic member 71 alone, it is possible to reduce the stroke of the first elastic member 71 in the axial direction A when providing the impact absorbing function of the end damper 70.

In the steering system 1, the first elastic member 71 can be expanded and deformed in the radial direction while being compressed and deformed in the axial direction A, by being held between the large-diameter member 60 and the stopper portion 27 in the axial direction A. The second elastic member 72 is disposed adjacent to the first elastic member 71 in the radial direction, and is elastically deformed in the radial direction by receiving a load resulting from the expansion deformation of the first elastic member 71 in the radial direction. With this configuration, when the first elastic member 71 is expanded and deformed in the radial direction due to the compression deformation in the axial direction A, the expansion deformation contributes to impact absorption by elastic deformation of the second elastic member 72. Thus, according to the steering system 1, compared to the configuration that absorbs impact by elastic deformation of the first elastic member 71 alone, it is possible to reduce the stroke of the first elastic member 71 in the axial direction A when providing the impact absorbing function of the end damper 70.

In the steering system 1, the first elastic member 71 includes the projecting portion 71a projecting radially outward from the outer peripheral surface of the main body thereof, and the rack housing 20 includes the groove portion 25 to which the projecting portion 71a fits. With this configuration, the first elastic member 71 can be positioned with respect to the rack housing 20 in the axial direction A by fitting the projecting portion 71a and the groove portion 25 to each other.

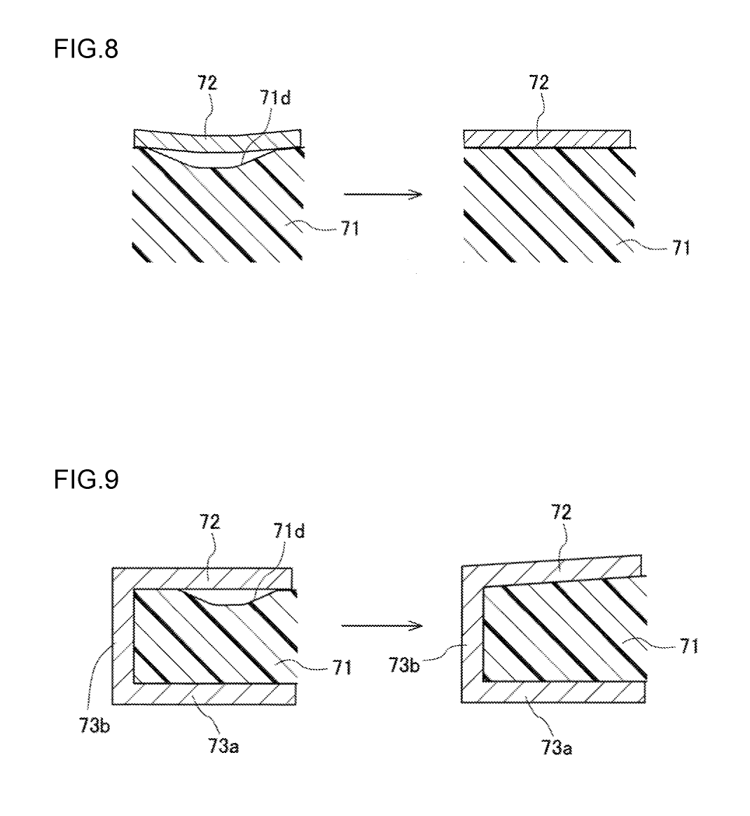

The following describes modifications of the above embodiment. In the above embodiment, the second elastic member 72 that is elastically deformed in the radial direction by receiving a load resulting from the expansion deformation of the first elastic member 71 in the radial direction due to the compression deformation in the axial direction A is formed in a cylindrical annular shape, and has a flat plate shape in cross section as illustrated in FIGS. 4 and 5. However, the present invention is not limited thereto. The second elastic member 72 may be formed in a substantially cylindrical shape, and have a recessed portion 72a such that the axial center portion extends radially inward, that is, the axial center portion is recessed radially inward in cross section as illustrated in the left of FIG. 8.

In this first modified embodiment, after the recessed portion 71d is filled by expansion deformation of the first elastic member 71 in the radial direction, the second elastic member 72 receives a load resulting from the expansion deformation. Thus, the second elastic member 72 is pushed radially outward at the axial center portion, and elastically deformed. The second elastic member 72 is elastically deformed to eliminate the extension or recess defined by the recessed portion 72a described above and thus to have a flat plate shape in cross section as illustrated in the right of FIG. 8. Accordingly, the first modified embodiment can also achieve the same effects as those of the above embodiment.

In the embodiment described above, the second elastic member 72 is provided separately from the holding plate 73 interposed between the first elastic member 71 and the large-diameter member 60, and is provided separately from the ring plate 74 interposed between the first elastic member 71 and the stopper portion 27. However, the present invention is not limited thereto. The second elastic member 72 may be formed integrally with the holding plate 73 or the ring plate 74. For example, as illustrated in FIG. 9, the second elastic member 72 may be formed integrally with the holding plate 73 by connecting the end of the second elastic member 72 in the axially outward direction A− to the radially outer edge of the flange portion 73b of the holding plate 73.

In this second modified embodiment, after the recessed portion 71d is filled by expansion deformation of the first elastic member 71 in the radial direction, the second elastic member 72 receives a load resulting from the expansion deformation of the first elastic member 71. Thus, the second elastic member 72 is pushed and expanded radially outward, and elastically deformed. The second elastic member 72 is elastically deformed such that the end of the second elastic member 72 in the axially inward direction A+ is expanded radially outward with respect to a portion connected to the flange portion 73b as illustrated in the right of FIG. 9. Accordingly, the second modified embodiment can achieve the same effects as those of the above embodiment. Further, since the second elastic member 72 is formed integrally with the holding plate 73, the number of components can be reduced.

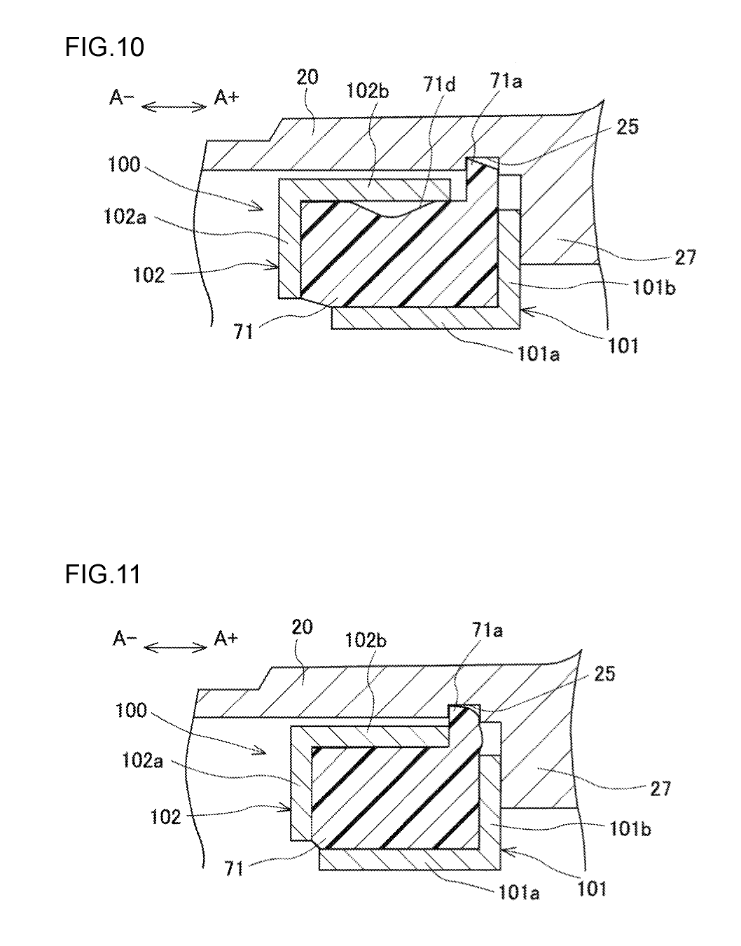

In the above embodiment, the end damper 70 includes the holding plate 73 including the cylindrical portion 73a and the flange portion 73b; the first elastic member 71 held by the holding plate 73; the second elastic member 72 provided separately from the holding plate 73, and the ring plate 74 provided separately from the second elastic member 72 and the holding plate 73. However, the present invention is not limited thereto. As illustrated in FIG. 10, an end damper 100 may include the first elastic member 71, and two plate members 101 and 102 having an L-shaped cross section and surrounding the first elastic member 71.

The plate member 101 includes a cylindrical portion 101a corresponding to the cylindrical portion 73a of the above embodiment, and a flange portion 101b corresponding to the ring plate 74. The plate member 102 further includes a flange portion 102a corresponding to the flange portion 73b of the above embodiment, and a cylindrical portion 102b corresponding to the second elastic member 72. An end of the cylindrical portion 101a of the plate member 101 in the axially outward direction A− and the radially inner edge of the flange portion 102a of the plate member 102 are disposed with a clearance therebetween so as not to come into contact with each other, even when the first elastic member 71 is compressed and deformed in the axial direction A. Further, the radially outer edge of the flange portion 101b of the plate member 101 and the end of the cylindrical portion 102b of the plate member 102 in the axially inward direction A+ are disposed with a clearance therebetween so as not to come into contact with each other, and not to hold the projecting portion 71a of the first elastic member 71 therebetween, even when the first elastic member 71 is compressed and deformed in the axial direction A.

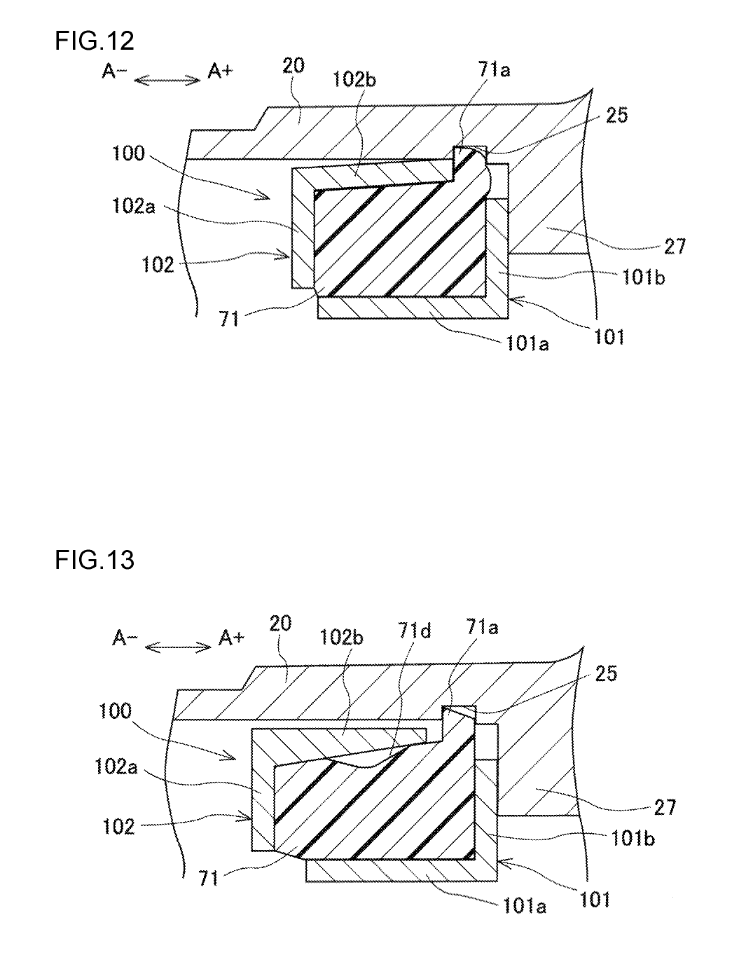

In the third modified embodiment, after the recessed portion 71d in the state of FIG. 10 is filled by expansion deformation of the first elastic member 71 in the radial direction as illustrated in FIG. 11, the cylindrical portion 102b receives a load resulting from the expansion deformation. Thus, the cylindrical portion 102b is pushed and expanded radially outward, and elastically deformed. The cylindrical portion 102b is elastically deformed such that the end of the cylindrical portion 102b in the axially inward direction A+ is expanded radially outward with respect to a portion connected to the flange portion 102a as illustrated in FIG. 12. Accordingly, the third modified embodiment can also achieve the same effects as those of the above embodiment. Further, since the flange portion 102a corresponding to the flange portion 73b and the cylindrical portion 102b corresponding to the second elastic member 72 are integrally formed, and the cylindrical portion 101a corresponding to the cylindrical portion 73a and the flange portion 101b corresponding to the ring plate 74 are integrally formed, the number of components can be reduced.

Note that in the third modified embodiment, the cylindrical portion 102b of the plate member 102 may be formed in a cylindrical annular shape, and have a flat plate shape with a constant radial thickness in cross section as illustrated in FIG. 10. However, the present invention is not limited thereto. As illustrated in FIG. 13, the cylindrical portion 102b may be formed in a tapered shape to have a plate shape in cross section with a radial thickness that decreases from a portion connected to the flange portion 102a in the axial direction toward an axial distal end thereof in the axially inward direction A+. In the fourth embodiment, compared to a cylindrical portion not having a tapered shape, it is possible to elastically deform the tapered cylindrical portion 102b with a small load, easily cause elastic deformation of the tapered cylindrical portion 102b, and adjust the amount of elastic deformation of a member corresponding to the second elastic member 72.

In the above embodiment, the second elastic member that is elastically deformed by receiving a load resulting from the expansion deformation of the first elastic member 71 in the radial direction due to the compression deformation in the axial direction A is the second elastic member 72 that is disposed adjacent to and on the radially outer side of the first elastic member 71. However, the present invention is not limited thereto. As illustrated in FIG. 15, a second elastic member 110 that is disposed adjacent to and on the radially inner side of the first elastic member 71 may be provided as the second elastic member that is elastically deformed by receiving a load resulting from the expansion deformation of the first elastic member 71 in the radial direction due to the compression deformation in the axial direction A. The second elastic member 110 may be provided in addition to, or in place of the second elastic member 72 disposed on the radially outer side of the first elastic member 71. The second elastic member 110 is provided in place of the cylindrical portion 73a of the holding plate 73.

The second elastic member 110 on the radially inner side may be formed in a substantially cylindrical shape, for example, and have a recessed portion such that the axial center portion extends radially outward, that is, the axial center portion is recessed radially outward in cross section. The second elastic member 110 may be elastically deformed to eliminate the extension or recess defined by the recessed portion and thus to have a flat plate shape in cross section.

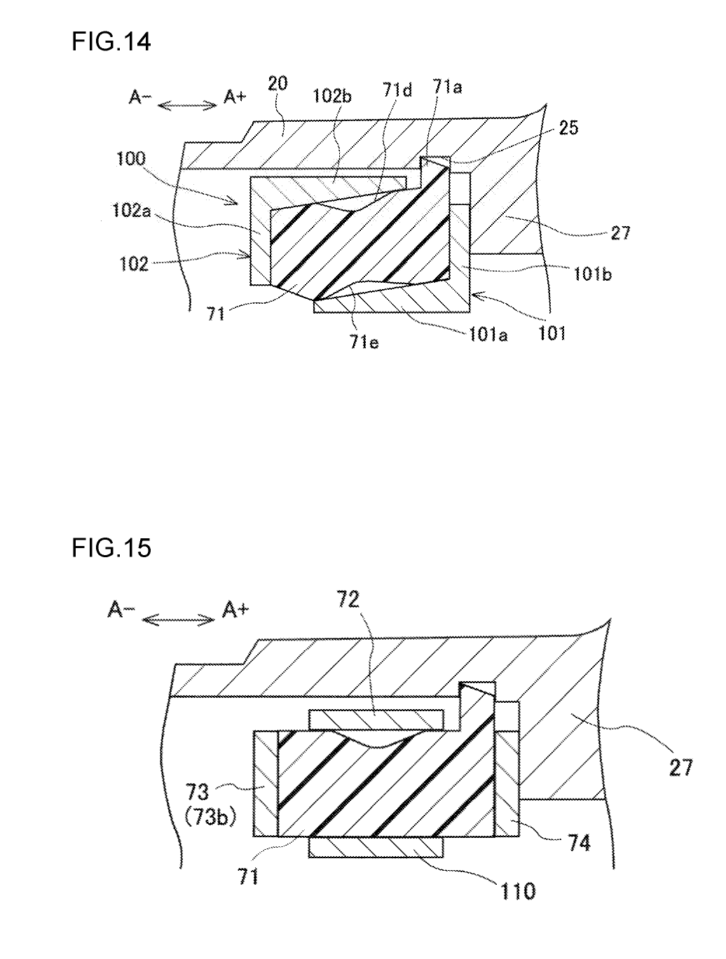

Further, for example, in the case where the second elastic member 110 is applied to the fourth modified embodiment described above, the cylindrical portion 101a of the plate member 101 corresponds to the second elastic member 110 as illustrated in FIG. 14. Note that in this configuration, the first elastic member 71 may have a recessed portion 71e that is recessed radially outward on the inner peripheral side. In this fifth modified embodiment, after the recessed portion 71d is filled by expansion deformation of the first elastic member 71 in the radial direction, the cylindrical portion 102b corresponding to the second elastic member 72 receives a load resulting from the expansion deformation. Thus, the cylindrical portion 102b is pushed and expanded radially outward, and elastically deformed. Further, after the recessed portion 71e is filled by expansion deformation of the first elastic member 71 in the radial direction, the cylindrical portion 101a corresponding to the second elastic member 110 receives a load resulting from the expansion deformation. Thus, the cylindrical portion 101a is pushed and expanded radially inward, and elastically deformed. The cylindrical portion 101a is elastically deformed such that the end of the cylindrical portion 101a in the axially outward direction A− is expanded radially inward with respect to a portion connected to the flange portion 101b. Note that the cylindrical portion 101a is disposed with a clearance from the rack shaft 13 so as not to come into contact with the outer peripheral surface of the rack shaft 13 even when the cylindrical portion 101a expands radially inward. Accordingly, the fifth embodiment can achieve the same or better effects than those of the above embodiment. That is, it is possible to further reduce the stroke of the first elastic member 71 in the axial direction A when providing the impact absorbing function of the end damper 70.

In the fourth and fifth modified embodiments, the cylindrical portion 102b of the plate member 102 having the cylindrical portion 102b that is adjacent to and on the radially outer side of the first elastic member 71 is an annular member extending in the axially inward direction A+ while its end in the axially outward direction A− is connected to the flange portion 102a. Further, the cylindrical portion 101a of the plate member 101 having the cylindrical portion 101a that is adjacent to and on the radially inner side of the first elastic member 71 is an annular member extending in the axially outward direction A− while its end in the axially inward direction A+ is connected to the flange portion 101b. However, the present invention is not limited thereto. Contrarily, the cylindrical portion 102b of the plate member 102 having the cylindrical portion 102b that is adjacent to and on the radially outer side of the first elastic member 71 may be an annular member extending in the axially outward direction A− while its end in the axially inward direction A+ is connected to the flange portion 102a. Further, the cylindrical portion 101a of the plate member 101 having the cylindrical portion 101a that is adjacent to and on the radially inner side of the first elastic member 71 may be an annular member extending in the axially inward direction A+ while its end in the axially outward direction A− is connected to the flange portion 101b.

However, in the modified embodiment, although the projecting portion 71a of the first elastic member 71 may be disposed at the end of the first elastic member 71 in the axially outward direction A− in place of the end in the axially inward direction A+, the projecting portion 71a may be disposed at the end of the first elastic member 71 in the axially inward direction A+. In this configuration, the cylindrical portion 102b may have a through-hole through which the projecting portion 71a extends, and the projecting portion 71a may project radially outward through the through-hole, and fit to the groove portion 25 of the rack housing 20.

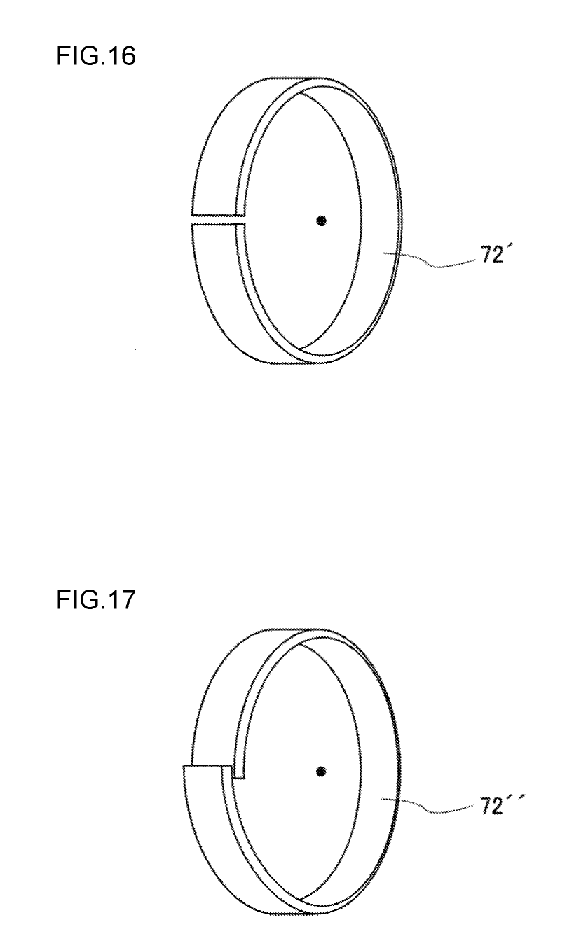

In the above embodiment, the second elastic member that is elastically deformed by receiving a load resulting from the expansion deformation of the first elastic member 71 in the radial direction due to the compression deformation in the axial direction A is the second elastic member 72 that is a plate member formed in a cylindrical annular shape. However, the present invention is not limited thereto. As long as the second elastic member has an elasticity in the radial direction, the second elastic member may be a second elastic member 72′ having a strip-shaped cut extending throughout the axial length at a part of the whole circumference, as illustrated in FIG. 16. Contrarily, as illustrated in FIG. 17, the second elastic member may be a second elastic member 72″ having a strip-shaped overlapping portion where part of the member is stacked on another part of the member throughout the axial length at a part of the whole circumference. Alternatively, as long as the second elastic member 72 has elasticity in the radial direction, the second elastic member 72 may be formed in a net shape.

In the above embodiment, the first elastic member 71 has the recessed portion 71d that is recessed radially inward on the outer peripheral side, and the recessed portion 71d defines a closed clearance space enclosed by the first elastic member 71 and the second elastic member 72. That is, the first elastic member 71 and the second elastic member 72 are disposed adjacent to each other with the recessed portion 71d interposed therebetween. However, the present invention is not limited thereto. The first elastic member 71 and the second elastic member 72 may be disposed adjacent to each other without interposing a recessed portion or a clearance therebetween as long as the second elastic member 72 can be elastically deformed by a load resulting from the elastic deformation of the first elastic member 71.

In the above embodiment, the recessed portion 71d that is partially filled when the first elastic member 71 is compressed and deformed in the axial direction A is the clearance space formed between the first elastic member 71 and the second elastic member 72. However, the present invention is not limited thereto. The clearance space may be formed, for example, between the first elastic member 71 and the cylindrical portion 73a of the holding plate 73, or between the first elastic member 71 and the flange portion 73b of the holding plate 73, as long as the clearance space is partially filled by expansion deformation of the elastic member 71 when the first elastic member 71 is compressed and deformed in the axial direction A.

In the above embodiment, the rack shaft 13 included in the rack-and-pinion mechanism is used as a steered shaft that changes the direction of the steered wheels. However, the present invention is not limited thereto. A shaft with no rack teeth may be used as a steered shaft that changes the direction of the steered wheels, and may be applied to a steer-by-wire steering system in which a pinion is not provided and a steering wheel and a steered shaft are not mechanically coupled.

What is claimed is:

1. A steering system comprising:
a steered shaft that is coupled to steered wheels, and changes a direction of the steered wheels by moving in an axial direction;
shaft end members that are attached one to each axial end of the steered shaft, and move in the axial direction along with the movement of the steered shaft;
a cylindrical housing having an insertion hole for insertion of the steered shaft, and stopper portions which the corresponding shaft end members move to approach and separate from, the housing holding the steered shaft and the shaft end members movably in the axial direction; and
end dampers each of which absorbs impact by being held between the corresponding shaft end member and the corresponding stopper portion in the axial direction;
wherein each of the end dampers includes
a first elastic member that is disposed between the shaft end member and the stopper portion, and is elastically deformed by being held between the shaft end member and the stopper portion in the axial direction, and
a second elastic member that is disposed adjacent to the first elastic member, and is elastically deformed such that an elastic modulus of the entire end damper is greater than an elastic modulus of the first elastic member, by receiving a load resulting from the elastic deformation of the first elastic member.

2. The steering system according to claim 1, wherein:
the first elastic member is expandable and deformable in a radial direction while being compressed and deformed in the axial direction, by being held between the shaft end member and the stopper portion in the axial direction; and
the second elastic member is disposed adjacent to the first elastic member in the radial direction, and is elastically deformed in the radial direction by receiving a load resulting from the expansion deformation of the first elastic member in the radial direction.

3. The steering system according to claim 2, wherein:
each of the end dampers includes a plate member holding the first elastic member and including an abutment portion interposed between the first elastic member and the shaft end member or the stopper portion; and
the second elastic member is formed integrally with the abutment portion of the plate member.

4. The steering system according to claim 3, wherein the second elastic member is formed in a tapered shape such that a radial thickness thereof decreases from an axial connection portion connected to the abutment portion toward an axial distal end thereof.

5. The steering system according to claim 1, wherein the second elastic member is an annular member having an axial center portion extending radially inward or radially outward.

6. The steering system according to claim 1, wherein:
the first elastic member includes a projecting portion projecting radially outward from an outer peripheral surface of a main body thereof; and
the housing includes a groove portion to which the projecting portion fits.

7. The steering system according to claim 1, wherein:
each of the end dampers has a clearance space that is filled with part of the first elastic member when the first elastic member is elastically deformed; and
the load resulting from the elastic deformation of the first elastic member and received by the second elastic member after the clearance space is filled with part of the first elastic member is greater than the load before the clearance space is filled.
